(19) United States
(12) Patent Application Publication
(10) Pub. No.: US 2026/0168582 A1
(43) Pub. Date: Jun. 18, 2026

(54) VALVE ASSEMBLY AND SUBSTRATE PROCESSING APPARATUS INCLUDING THE SAME

(71) Applicant: SEMES CO., LTD., Cheonan-si (KR)

(72) Inventor: Ju Dong LEE, Cheonan-si (KR)

(73) Assignee: SEMES CO., LTD., Cheonan-si (KR)

(21) Appl. No.: 19/420,899

(22) Filed: Dec. 16, 2025

(30) Foreign Application Priority Data
Dec. 18, 2024 (KR) 10-2024-0190131

(51) Int. Cl. F16K 7/17; B08B 3/04; F16K 31/122

(52) U.S. Cl. CPC F16K 7/17; B08B 3/04; F16K 31/1221

(57) ABSTRACT

Provided is an apparatus for processing a substrate. The apparatus includes a valve assembly. The valve assembly includes: a body which has an inlet port and an outlet port, and is formed with a driving space and a flow passage therein; a diaphragm for opening and closing the flow passage; and a plunger for moving the diaphragm between a closed position that closes the flow passage and an open position that opens the flow passage, and the plunger includes: a plate; and a shaft, the body is formed with a first hole and a second hole connected to the driving space to exhaust atmosphere in the driving space, the first hole and the second hole are disposed to be spaced apart from each other in a moving direction of the plunger.

### CROSS-REFERENCE TO RELATED APPLICATION

This application claims priority to and the benefit of Korean Patent Application No. 10-2024-0190131 filed in the Korean Intellectual Property Office on Dec. 18, 2024, the entire contents of which are incorporated herein by reference.

### TECHNICAL FIELD

The present invention relates to a valve assembly, and a substrate processing apparatus including the same.

### BACKGROUND ART

In general, various processes, such as photo process, etching process, ion implantation process, and deposition process, are performed to manufacture semiconductor devices. Further, before and after the processes are performed, a cleaning process for cleaning particles remaining on a substrate is performed.

In general, the cleaning process removes particles remaining on the substrate by supplying a cleaning liquid including chemicals to the substrate through a nozzle. The nozzle receives the cleaning liquid from a cleaning liquid supply pipe, and a valve is installed in the cleaning liquid supply pipe to open and close an internal flow path thereof.

FIG. 1 is a diagram schematically illustrating a valve assembly generally installed in a cleaning liquid supply pipe. Referring to FIG. 1, the valve assembly 5000 includes a body 5100, a plunger 5300, a spring 5500, a diaphragm 5700, and a gas unit 5900. A driving space 5110 in which the plunger 5300 is driven is formed on an upper end of the body 5100, and a flow passage 5130 through which a cleaning liquid may flow is formed on a lower end thereof. The flow passage 5130 is opened and closed by the diaphragm 5700.

A first hole 5151 and a second hole 5153 through which air may flow are formed in the body 5100, and the gas unit 5900 supplies air to the driving space 5110 through the first hole 5151 or exhausts the air in the driving space 5110 to drive the plunger 5300, and thus the diaphragm 5700 may open and close the flow passage 5130.

When the plunger 5300 descends, air is exhausted through the first hole 5151, which is a single flow path, so that the speed at which the flow passage 5130 is closed is maintained at a single speed. When the closing speed is increased, the diaphragm 5700 collides with the cleaning liquid to generate a number of particles, and when the closing speed is slow, it takes a lot of time to open and close the valve, thereby lowering process efficiency.

### SUMMARY OF THE INVENTION

The present invention has been made in an effort to provide a valve assembly capable of efficiently processing a substrate and a substrate processing apparatus including the same.

The present invention has also been made in an effort to provide a valve assembly that increases a valve closing speed and minimizes the generation of particles at the same time when a diaphragm closes a flow passage, and a substrate processing apparatus including the same.

Effects of the present disclosure are not limited to those described above and effects not stated above will be clearly understood to those skilled in the art from the specification and the accompanying drawings

An exemplary embodiment of the present disclosure, an apparatus for processing a substrate, the apparatus comprising: a housing having a treatment space; a support unit for supporting and rotating a substrate in the treatment space; a nozzle for supplying a treatment liquid to an upper surface of the substrate; and a treatment liquid supply pipe for flowing the treatment liquid to the nozzle, wherein a valve assembly for opening and closing an internal flow path is installed in the treatment liquid supply pipe, the valve assembly includes: a body which has an inlet port and an outlet port, and is formed with a driving space and a flow passage connecting the inlet port and the outlet port therein; a diaphragm provided to open and close the flow passage and partition the flow passage from the driving space; and a plunger placed in the driving space and moving the diaphragm between a closed position that closes the flow passage and an open position that opens the flow passage, the plunger includes: a plate having a size corresponding to the driving space when viewed from the top; and a shaft extending from the plate, the body is formed with a first hole and a second hole connected to the driving space to exhaust atmosphere in the driving space, the first hole and the second hole are disposed to be spaced apart from each other in a moving direction of the plunger, and when the diaphragm is in the open position, the first hole and the second hole may be located between the plate and the diaphragm.

According to the exemplary embodiment of the present invention, wherein the second hole may be positioned on a path through which the plate is moved to switch the diaphragm from the open position to the closed position.

According to the exemplary embodiment of the present invention, wherein the second hole is positioned farther from the diaphragm than the first hole, and a first main pipe in which gas flows may be connected to the first hole.

According to the exemplary embodiment of the present invention, wherein a flow rate adjusting unit for controlling a flow rate of gas passing through an inside of the first main pipe may be installed in the first main pipe.

According to the exemplary embodiment of the present invention, wherein the flow rate adjusting unit may includes: a needle valve installed in the first main pipe; and a first parallel pipe disposed in parallel with the needle valve and including a check valve installed.

According to the exemplary embodiment of the present invention, wherein the flow rate adjusting unit may be an orifice.

According to the exemplary embodiment of the present invention, wherein a second main pipe through which gas flows is connected to the second hole, and the second main pipe may be connected to the first main pipe on a side opposite to the first hole with respect to the flow rate adjusting unit.

According to the exemplary embodiment of the present invention, wherein the flow rate adjusting unit may be provided only in the first main pipe among the first main pipe and the second main pipe.

According to the exemplary embodiment of the present invention, wherein the first hole and the second hole are configured such that, when the diaphragm is moved from the open position to the closed position, the diaphragm moves from the open position to a preset position at a first speed and moves from the preset position to the closed position at a second speed different from the first speed.

According to the exemplary embodiment of the present invention, wherein the first speed may be higher than the second speed.

According to the exemplary embodiment of the present invention, wherein the valve assembly further may includes, a gas supply source for supplying gas to the first main pipe; an exhaust pipe connected to the first main pipe between points where the gas supply source and the second main pipe are connected to the first main pipe; a supply valve installed in the first main pipe between points where the gas supply source and the exhaust pipe are connected to the first main pipe to open and close the first main pipe; and an exhaust valve installed in the exhaust pipe to open and close the exhaust pipe.

According to the exemplary embodiment of the present invention, further comprising: an elastic body combined with the other surface of the plate and the body to provide elastic force to the plate; and a controller for controlling the supply valve and the exhaust valve, the controller supplies gas to the driving space to move the diaphragm from the closed position to the open position by opening the supply valve and closing the exhaust valve, and may moves the diaphragm from the open position to the closed position by the elastic force of the elastic body by closing the supply valve and opening the exhaust valve.

According to the exemplary embodiment of the present invention, wherein the flow passage includes: an inlet path connected to the inlet port; an outlet path connected to the outlet port; and a buffer space provided between the inlet path and the outlet path, and the diaphragm may has a coupling part fixedly coupled to the body; and an opening/closing part extending from the coupling part and opening/closing an outlet of the inlet path or an inlet of the outlet path.

An exemplary embodiment of the present disclosure, a valve assembly comprising: a body which has an inlet port and an outlet port, and is formed with a driving space and a flow passage connecting the inlet port and the outlet port therein; a diaphragm provided to open and close the flow passage and partition the flow passage from the driving space; and a plunger placed in the driving space and moving the diaphragm between a closed position that closes the flow passage and an open position that opens the flow passage, wherein the plunger includes: a plate having a size corresponding to the driving space when viewed from the top; and a shaft extending from the plate, the body is formed with a first hole and a second hole connected to the driving space to exhaust atmosphere in the driving space or supply gas to the driving space, the first hole and the second hole are disposed to be spaced apart from each other in a moving direction of the plunger, and when the diaphragm is in the open position, the first hole and the second hole may be located between the plate and the diaphragm.

According to the exemplary embodiment of the present invention, wherein the second hole may be positioned on a path through which the plate is moved to switch the diaphragm from the open position to the closed position.

According to the exemplary embodiment of the present invention, wherein a first main pipe through which gas flows is connected to the first hole, and a flow rate adjusting unit for controlling a flow rate of gas passing through an inside of the first main pipe may be installed in the first main pipe.

According to the exemplary embodiment of the present invention, wherein the first hole and the second hole are configured such that, when the diaphragm is moved from the open position to the closed position, the diaphragm moves from the open position to a preset position at a first speed and moves from the preset position to the closed position at a second speed different from the first speed.

According to the exemplary embodiment of the present invention, wherein the first speed may be higher than the second speed.

An exemplary embodiment of the present disclosure, an apparatus for processing a substrate, the apparatus comprising: a housing having a treatment space; a support unit for supporting and rotating a substrate in the treatment space; a nozzle for supplying a treatment liquid to an upper surface of the substrate; and a treatment liquid supply pipe for flowing the treatment liquid to the nozzle, wherein a valve assembly for opening and closing an internal flow path is installed in the treatment liquid supply pipe, the valve assembly includes: a body which has an inlet port and an outlet port, and is formed with a driving space and a flow passage connecting the inlet port and the outlet port therein; a diaphragm provided to open and close the flow passage and partition the flow passage from the driving space; and a plunger placed in the driving space and moving the diaphragm between a closed position that closes the flow passage and an open position that opens the flow passage, the plunger includes: a plate having a size corresponding to the driving space when viewed from the top; and a shaft extending from the plate, the body is formed with a first hole and a second hole connected to the driving space to exhaust atmosphere in the driving space or supply gas to the driving space, the first hole and the second hole are disposed to be spaced apart from each other in a moving direction of the plunger, and when the diaphragm is in the open position, the first hole and the second hole are located between the plate and the diaphragm, the second hole is positioned on a path through which the plate is moved to switch the diaphragm from the open position to the closed position, a first main pipe, through which gas flows and in which a flow rate adjusting unit is installed, is connected to the first hole, a second main pipe through which gas flows is connected to the second hole, and the second main pipe may be connected to the first main pipe on a side opposite to the first hole with respect to the flow rate adjusting unit.

According to the exemplary embodiment of the present invention, wherein the valve assembly further includes: a gas supply source for supplying gas to the first main pipe; an exhaust pipe connected to the first main pipe between points where the gas supply source and the second main pipe are connected to the first main pipe; a supply valve installed in the first main pipe between points where the gas supply source and the exhaust pipe are connected to the first main pipe to open and close the first main pipe; and an exhaust valve installed in the exhaust pipe to open/close the exhaust pipe, the apparatus further comprises: an elastic body combined with the plate and the body to provide elastic force to the plate; and a controller for controlling the supply valve and the exhaust valve, and the controller supplies gas to the driving space to move the diaphragm from the closed position to the open position by opening the supply valve and closing the exhaust valve, and may moves the diaphragm from the open position to the closed position by the elastic force of the elastic body by closing the supply valve and opening the exhaust valve.

According to the exemplary embodiment of the present invention, it is possible to improve substrate processing efficiency.

According to the exemplary embodiment of the present invention, it is possible to minimize the generation of particles when a diaphragm closes a flow passage.

According to the exemplary embodiment of the present invention, it is possible to improve processing efficiency.

Effects of the present disclosure are not limited to those described above and effects not stated above will be clearly understood to those skilled in the art from the specification and the accompanying drawings

### BRIEF DESCRIPTION OF THE DRAWINGS

FIG. 1 is a diagram schematically illustrating a valve assembly generally installed in a cleaning liquid supply pipe.

FIG. 2 is a diagram schematically illustrating a substrate processing apparatus according to an exemplary embodiment of the present invention.

FIG. 3 is a diagram schematically illustrating an example of a process chamber of FIG. 2.

FIG. 4 is a diagram schematically illustrating an example of a valve assembly of FIG. 3.

FIG. 5 to FIG. 7 are diagrams schematically illustrating a series of processes of moving a diaphragm from an closed position to a open position according to an exemplary embodiment.

FIG. 8 to FIG. 10 are diagrams schematically illustrating a series of processes of moving the diaphragm from the open position to the closed position according to an exemplary embodiment.

FIG. 11 is a graph schematically illustrating closing speeds when the flow passages of the valve assembly according to the exemplary embodiment of the present invention and a flow passage of the valve assembly in the related art are closed.

FIGS. 12 to 15 are diagrams schematically illustrating a structure of a valve assembly according to another exemplary embodiment.

### DETAILED DESCRIPTION

Hereinafter, an exemplary embodiment of the present invention will be described more fully hereinafter with reference to the accompanying drawings, in which exemplary embodiments of the invention are illustrated. However, the present invention may be variously implemented and is not limited to the following exemplary embodiments. In the following description of the present invention, a detailed description of known functions and configurations incorporated herein is omitted to avoid making the subject matter of the present invention unclear. In addition, the same reference numerals are used throughout the drawings for parts having similar functions and actions.

Unless explicitly described to the contrary, the word “include” will be understood to imply the inclusion of stated elements but not the exclusion of any other elements. It will be appreciated that terms “including” and “having” are intended to designate the existence of characteristics, numbers, operations, operations, constituent elements, and components described in the specification or a combination thereof, and do not exclude a possibility of the existence or addition of one or more other characteristics, numbers, operations, operations, constituent elements, and components, or a combination thereof in advance.

Singular expressions used herein include plurals expressions unless they have definitely opposite meanings in the context. Accordingly, shapes, sizes, and the like of the elements in the drawing may be exaggerated for clearer description.

Terms, such as first and second, are used for describing various constituent elements, but the constituent elements are not limited by the terms. The terms are used only to discriminate one constituent element from another constituent element. For example, without departing from the scope of the invention, a first constituent element may be named as a second constituent element, and similarly a second constituent element may be named as a first constituent element.

It should be understood that when one constituent element referred to as being “coupled to” or “connected to” another constituent element, one constituent element may be directly coupled to or connected to the other constituent element, but intervening the other constituent elements may also be present. In contrast, when one constituent element is “directly coupled to or “directly connected to” another constituent element, it should be understood that there are no intervening element present. Other expressions describing the relationship between the constituent elements, such as “between ˜and ˜”, “just between ˜and ˜”, or “adjacent to ˜” and “directly adjacent to ˜” should be interpreted similarly.

All terms used herein including technical or scientific terms have the same meanings as meanings which are generally understood by those skilled in the art unless they are differently defined. Terms defined in generally used dictionary shall be construed that they have meanings matching those in the context of a related art, and shall not be construed in ideal or excessively formal meanings unless they are clearly defined in the present application.

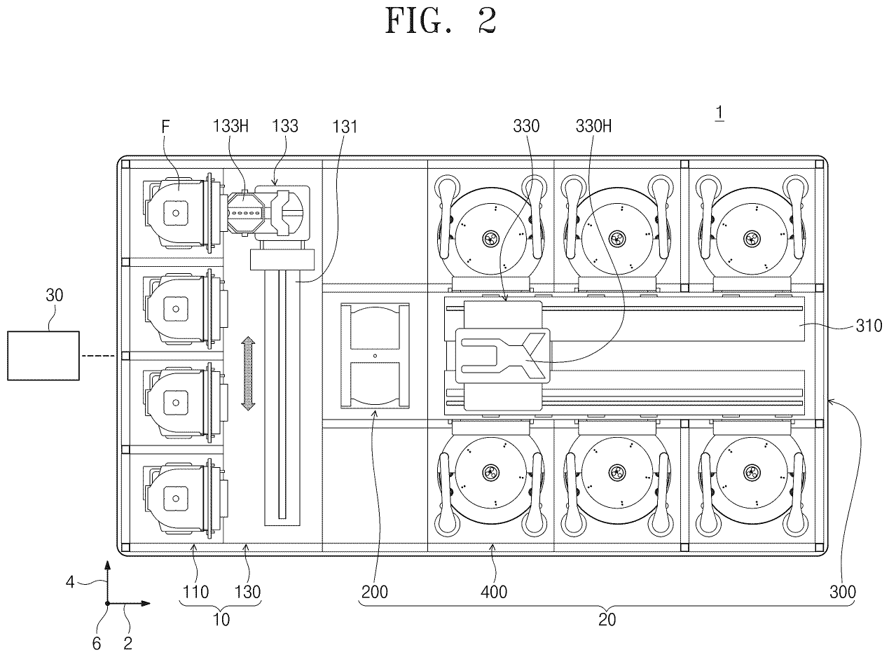

Hereinafter, an exemplary embodiment of the present invention will be described with reference to FIGS. 2 to 15.

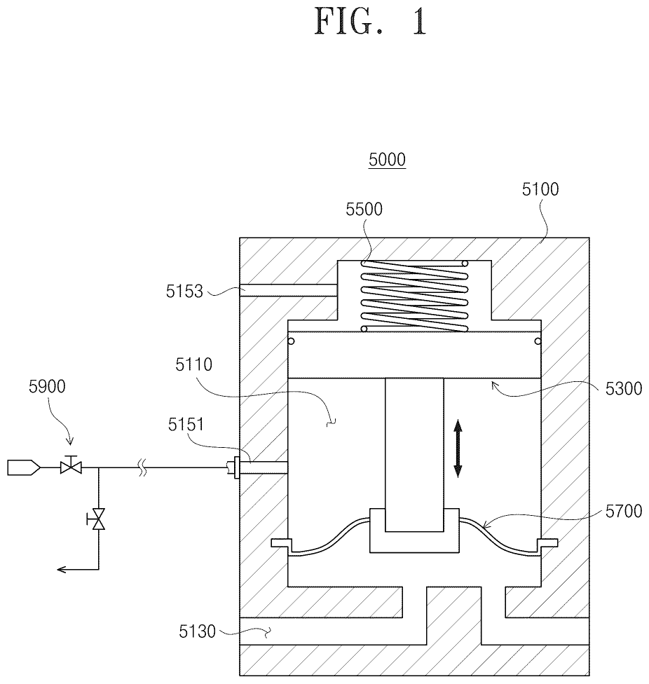

FIG. 2 is a top plan view schematically illustrating a substrate processing apparatus according to an exemplary embodiment of the present invention. Referring to FIG. 1, a substrate processing apparatus 1 includes an index module 10, a treating module 20, and a controller 30. According to the exemplary embodiment, the index module 10 and the treating module 20 are disposed along one direction. Hereinafter, the direction in which the index module 10 and the treating module 20 are disposed is referred to as a first direction 2, and when viewed from above, a direction perpendicular to the first direction 2 is referred to as a second direction 4, and a direction perpendicular to a plane including both the first direction 2 and the second direction 4 is referred to as a third direction 6.

The index module 10 transfers a substrate W from a container F in which the substrate W is accommodated to the treating module 20 processing the substrate W. The index module 10 accommodates the substrate W completely processed in the treating module 20 in the container F. A longitudinal direction of the index module 10 is provided in the second direction 4. The index module 10 includes a load port 110 and an index frame 130.

The container F in which the substrate W is accommodated is seated on the load port 110. Based on the index frame 130, the load port 110 is located at a side opposite to the treating module 20. A plurality of load ports 110 may be provided. The plurality of load ports 110 may be arranged in a line along the second direction 4. The number of load ports 110 may increase or decrease according to the process efficiency and footprint conditions of the treating module 20.

A plurality of slots (not illustrated) for accommodating the substrates W in a state of being horizontally arranged with respect to the ground is formed in the carrier F. As the container F, an airtight container, such as a Front Open Unified Pod (FOUP), may be used. The container F may be placed on the load port 110 by a transfer means (not illustrated), such as an overhead transfer, an overhead conveyor, or an automatic guided vehicle, or an operator.

An index rail 131 and an index robot 133 are provided inside the index frame 130. The index rail 131 is provided inside the index frame 130 along the second direction 4 in its longitudinal direction. The index robot 133 may transfer the substrate W. The index robot 133 may transfer the substrate W between the index module 10 and a buffer unit 200 to be described later.

The index robot 133 may be provided on the index rail 131 to be movable along the second direction 4. The index robot 133 includes a hand 133H. The substrate W may be placed on the hand 133H. The hand 133H is provided to be able to move forward and backward in the first direction 2. Also, the hand 133H may be provided to rotate around the third direction 6 and be movable along the third direction 6. A plurality of hands 133H may be provided. A plurality of hands 133H may be provided to be spaced apart from each other in the vertical direction. A plurality of hands 133H may move forward, backward, and rotate independently of each other.

The treating module 20 includes a buffer unit 200, a transfer chamber 300, and a process chamber 400. The buffer unit 200 provides a space in which the substrate W loaded into the treating module 20 and the substrate W unloaded from the treating module 20 stay temporarily. The transfer chamber 300 provides a space for transferring the substrate W between the buffer unit 200 and the process chamber 400 and between the process chambers 400. The process chamber 400 may perform a liquid treatment process for liquid-treating the substrate W by supplying liquid onto the substrate W. For example, the liquid treatment process may be a cleaning process for cleaning the substrate W with a cleaning liquid.

The buffer unit 200 may be disposed between the index module 130 and the transfer chamber 300. The buffer unit 200 may be located at one end of the transfer chamber 300. A slot (not illustrated) in which the substrate W is placed is provided in the buffer unit 200. A plurality of slots (not illustrated) is provided to be spaced apart from each other along the third direction 6. A front face and a rear face of the buffer unit 200 are opened. The front face is a face facing the index module 10, and the rear face is a face facing the transfer frame 300. The index robot 133 may approach the buffer unit 200 through the front face, and the transfer robot 330 to be described below may approach the buffer unit 200 through the rear face.

The transfer chamber 300 may be provided so that a longitudinal direction thereof is the first direction 2. The process chambers 400 may be disposed on opposite sides of the transfer chamber 300, respectively. The process chamber 400 may be disposed on a side portion of the transfer chamber 300. The transfer chamber 300 and the process chamber 400 may be disposed along the second direction 4.

According to an example, the process chambers 400 may be disposed at opposite sides of the transfer chamber 300, and the process chambers 400 may be provided in an arrangement of A×B (where A and B are each natural number equal to or greater than 1) at one side of the transfer chamber 300 along the first direction 2 and the third direction 6, respectively. Herein, A is the number of process chambers 400 provided in a row along the first direction 2, and B is the number of process chambers 400 provided in a row along the third direction 6. For example, when four or six process chambers 400 are provided at one side of the transfer chamber 300, the process chambers 400 may be arranged in a 2×2 or 2×3 arrangement. The number of process chambers 400 may increase or decrease. Unlike the above description, the process chamber 400 may be provided only at one side of the transfer chamber 300. Also, the process chamber 400 may be provided as a single layer at one side or opposite sides of the transfer chamber 300.

The transfer chamber 300 includes a guide rail 310 and a transfer robot 330. The guide rail 310 is provided within the transfer chamber 300 in the first direction 2 in a longitudinal direction thereof. The transfer robot 330 may be provided on the guide rail 310 to be able to move linearly along the first direction 2. The transfer robot 330 transfers the substrate W between the buffer unit 200 and the process chamber 400 and between the process chambers 400.

The transfer robot 330 includes a hand 330H on which the substrate W is placed. The hand 330H may be provided on the guide rail 310 to be movable along the first direction 2. Accordingly, the hand 330H may be moved forward and backward along the guide rail 310. Also, the hand 330H may be provided to rotate around the third direction 6 and be movable along the third direction 6. A plurality of hands 330H may be provided. A plurality of hands 330H may be provided to be spaced apart from each other in the vertical direction. The plurality of hands 330H may move forward, backward, and rotate independently of each other.

The process chamber 400 performs a process of liquid-treating the substrate W. For example, the process chamber 400 may be a chamber for performing a cleaning process for removing process by-products or the like attached to the substrate W. Each of the process chambers 400 may have the same structure. Alternatively, the process chamber 400 may have different structures depending on the type of process for treating the substrate W.

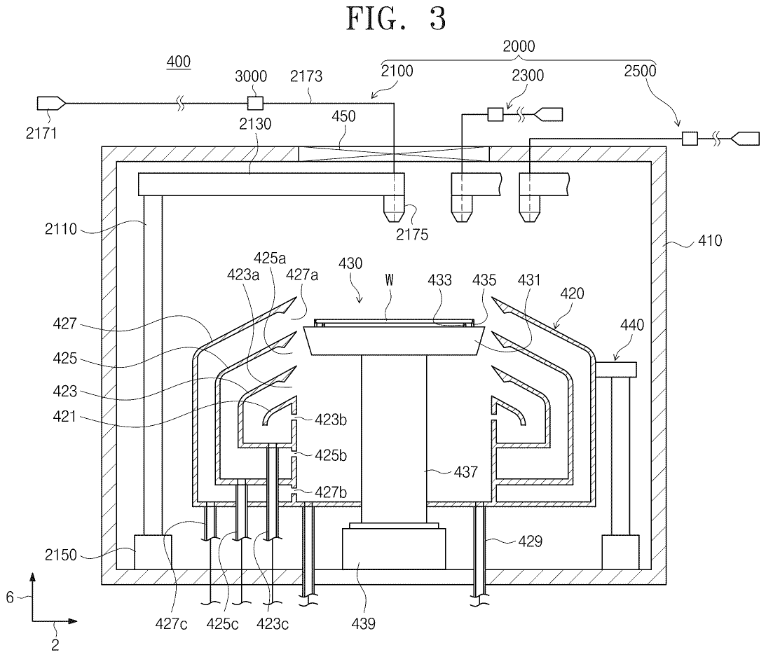

FIG. 3 is a diagram schematically illustrating the process chamber of FIG. 2 according to the exemplary embodiment. The process chamber 400 includes a housing 410, a treating container 420, a support unit 430, a liquid supply unit 2000, a lifting unit 440, and an airflow supply unit 450.

The housing 410 has an inner space. The housing 410 is provided in a generally rectangular parallelepiped shape. An opening (not illustrated) is formed at one side of the housing 410. The opening (not illustrated) functions as an entrance through which the substrate W is loaded into the inner space or the substrate W is unloaded from the inner space. The treating container 420, the support unit 430, the liquid supply unit 2000, and the lifting unit 440 are disposed within the housing 410.

The treating container 420 provides a treatment space in which the substrate W is processed. The treating container 420 has a treatment space with an open top. The treating container 420 may have a bowl shape. The substrate W is located in a treatment space and supplies a liquid onto the substrate W in the treatment space. The liquid may be provided in a plurality of types, and may be sequentially supplied onto the substrate W.

The treating container 420 may include a guide wall 421 and a plurality of recovery containers 423, 425, and 427. According to an example, the treating container 420 may include a guide wall 421, a first recovery container 423, a second recovery container 425, and a third recovery container 427. Each of the recovery containers 423, 425, and 427 separates and recovers a different liquid from among liquids used for the treatment of the substrate W. Each of the plurality of recovery containers 423, 425, and 427 has a recovery space for recovering a treatment liquid used for processing the substrate W.

The first recovery container 423 is provided in an annular ring shape surrounding the guide wall 421, and the second recovery container 425 is provided in an annular ring shape surrounding the first recovery container 423. The third recovery container 427 is provided in a ring shape surrounding the second recovery container 425. A space between the first recovery container 423 and the guide wall 421 functions as a first inlet 423a through which a liquid is introduced. A space between the first recovery container 423 and the second recovery container 425 functions as a second inlet 425a through which a liquid is introduced. A space between the second recovery container 425 and the third recovery container 427 functions as a third inlet 427a through which a liquid is introduced. The second inlet 425a is located above the first inlet 423a, and the third inlet 427a is located above the second inlet 425a.

The space between the lower end of the guide wall 421 and the first recovery container 423, the space between the lower end of the first recovery container 423 and the second recovery container 425, and the space between the lower end of the second recovery container 425 and the third recovery container 427 function as outlets 423b, 425b, and 427b through which fumes and gas generated from the liquid are discharged, respectively.

An exhaust pipe 429 is coupled to the lower end of the treating container 420. For example, the exhaust pipe 429 may be coupled to the lower end of the treating container 420 between the plurality of recovery containers 423, 425, and 427 and the support unit 430. The exhaust pipe 429 exhausts fumes and gas discharged from the respective outlets 423b, 425b, and 427b to the outside of the treatment space. A pressure reducing pump (not illustrated) may be installed at the exhaust pipe 429.

Recovery lines 423c, 425c, and 427c extending vertically in a direction below the bottom surfaces of the recovery containers 423, 425, and 427 are connected to the recovery containers 423, 425, and 427, respectively. The recovery lines 423c, 425c, and 427c discharge a treatment liquid introduced through the recovery containers 423, 425, and 427, respectively. The discharged treatment liquid may be reused by an external treatment liquid regeneration system (not illustrated).

The support unit 430 supports and rotates the substrate W in the treatment space. The support unit 430 includes a spin chuck 431, a support pin 433, a chuck pin 435, a rotation shaft 437, and a driver 439.

The top surface of the spin chuck 431 is generally provided in a circular shape when viewed from above. The top surface of the spin chuck 431 may be provided to have a larger diameter than the substrate W.

A plurality of support pins 433 is provided. The support pin 433 is disposed on the top surface of the spin chuck 431. The support pin 433 is disposed on the edge of the top surface of the spin chuck 431 to be spaced apart from each other at a predetermined interval. The support pin 433 protrudes upward from the top surface of the spin chuck 431. The support pins 433 are disposed to have an annular ring shape as a whole by a combination thereof. The support pin 433 supports the edge of the back surface of the substrate W so that the substrate W is spaced apart from the top surface of the spin chuck 431 by a predetermined distance.

A plurality of chuck pins 435 is provided. The chuck pin 435 is disposed to be relatively farther from the center of the spin chuck 433 than the support pin 431. The support pin 435 protrudes from the top surface of the spin chuck 431. The chuck pin 435 supports a side portion of the substrate W so as to prevent the substrate W from being separated from the correct position in the lateral direction when the substrate W is rotated. The chuck pin 435 is provided to be able to move linearly between a standby position and a support position along a radial direction of the spin chuck 431. For example, the chuck pin 435 may be linearly moved in the radial direction of the substrate W between the standby position and the support position. The standby position is a position farther from the center of the spin chuck 431 than the support position. When the substrate W is loaded into or unloaded from the support unit 430, the chuck pin 435 is located at the standby position, and the chuck pin 435 is located at the support position when performing a process on the substrate W. In the support position, the chuck pin 435 is in contact with the side portion of the substrate W.

The rotation shaft 437 is coupled to the spin chuck 431. For example, the rotation shaft 437 may be coupled to a lower surface of the spin chuck 431. The rotation shaft 437 may be provided such that a longitudinal direction thereof faces a vertical direction. The rotation shaft 437 is provided to be rotatable by receiving power from the driver 439. The rotation shaft 437 is rotated by the driver 439, thereby rotating the spin chuck 431. The driver 439 may vary the rotation speed of the rotation shaft 437. The driver 439 may be a motor that provides driving force.

The lifting unit 440 adjusts the relative height between the treating container 420 and the support unit 430. According to an example, the lifting unit 440 may linearly move the treating container 320 in the third direction 6. Unlike the description, the treating container 420 is fixedly installed, and the lifting unit 440 may move the support unit 440 in the vertical direction.

The airflow supply unit 450 supplies airflow to the inner space of the housing 410. The airflow supply unit 460 is installed on the ceiling of the housing 410. Gas supplied to the inner space of the housing 410 through the airflow supply unit 460 forms a descending airflow in the inner space. Gas by-products generated by the treatment process in the treatment space are discharged to the outside of the housing 410 through the exhaust pipe 429 by the descending airflow. The airflow supply unit 460 may be provided to a Fan Filter Unit (FFU).

The liquid supply unit 2000 supplies a treatment liquid onto the upper surface of the substrate W. The liquid supply unit 2000 supplies the treatment liquid to the upper surface of the substrate W supported by the support unit 430. The liquid supply unit 2000 may sequentially supply a plurality of treatment liquids onto the substrate W. The liquid supply unit 2000 includes a first liquid supply member 2100, a second liquid supply member 2300, and a third liquid supply member 2500.

Each of a first liquid, a second liquid, and a third liquid may be any one of a chemical, a rinse solution, and an organic solvent. For example, the chemical may include SC-1 (Standard Clean-1), SC-2 (Standard Clean-2), diluted sulfuric acid (H₂SO₄), diluted sulfuric acid peroxide, phosphoric acid (P₂O₅), hydrofluoric acid (HF), and ammonium hydroxide (NH₄OH). For example, the rinse solution may include water or deionized water (DIW). For example, the organic solvent may contain alcohol, such as isopropyl alcohol (IPA).

The first liquid supply member 2100 supplies the first liquid to the upper surface of the substrate W, the second liquid supply member 2300 supplies the second liquid to the upper surface of the substrate W, and the third liquid supply member 2500 supplies the third liquid to the upper surface of the substrate W. The first liquid supply member to the third liquid supply member 2100, 2300, and 2500 may sequentially supply the treatment liquid to the substrate W. However, the present invention is not limited thereto, and only one or two of the three liquids may be supplied onto the substrate W, and the liquid supply order may vary depending on the process.

Since the second liquid supply member 2300 and the third liquid supply member 2500 have the same or similar structures as the first liquid supply member 2100 to be described later, a description thereof will be omitted below.

The first liquid supply member 2100 includes a support rod 2110, an arm 2130, a driver 2150, and a nozzle 2170.

The support rod 2110 has a rod shape whose longitudinal direction faces the third direction 6. The support rod 2110 is provided to be rotatable with respect to its central axis by the driver 2150 to be described later.

The arm 2130 is coupled to an upper end of the support rod 2110. The arm 2130 extends vertically from the longitudinal direction of the support rod 2110. The first liquid supply nozzle 2175 is fixedly coupled to a distal end of the arm 2130. The arm 2130 swings and moves between a process position and the standby position by rotation of the support rod 2110.

The process position is a position where the first liquid supply nozzle 2175 faces the substrate W supported by the support unit 430 when viewed from above. The standby position is a position where the first liquid supply nozzle 2175 is out of the process position when viewed from above.

The driver 2150 is coupled with the support rod 2110. The driver 2150 provides driving force for rotating the support rod 2110. The driver 2150 may be a known motor for providing driving force.

The first liquid supply nozzle 2175 supplies the first liquid onto the substrate W. The first liquid supply nozzle 2175 is connected to the first liquid supply pipe 2173. The first liquid supply pipe 2173 flows the first liquid supplied from the first liquid supply source 2171 to the first liquid supply nozzle 2175.

A valve assembly 3000 capable of opening and closing the internal flow path of the first liquid supply pipe 2173 may be installed in the first liquid supply pipe 2173. The valve assembly 3000 may open the internal flow path of the first liquid supply pipe 2173 to supply the first liquid to the substrate W through the first liquid supply nozzle 2175, or close the internal flow path of the first liquid supply pipe 2173 to stop the supply of the first liquid to the substrate W.

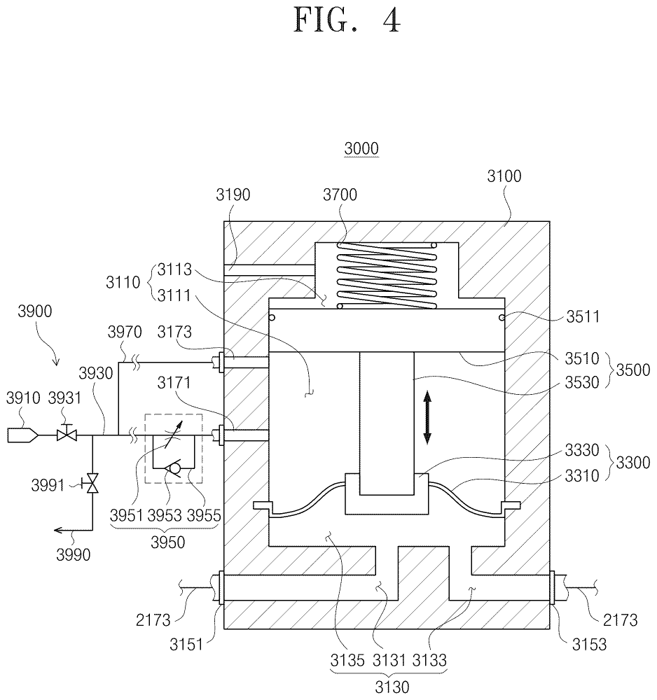

FIG. 4 is a schematic cross-sectional view of the valve assembly of FIG. 3 according to the exemplary embodiment. Referring to FIG. 4, the valve assembly 3000 includes a body 3100, a diaphragm 3300, a plunger 3500, an elastic body 3700, and a gas unit 3900.

The body 3100 may be provided in a generally cylindrical shape. The driving space 3110 and the flow passage 3130 are formed inside the body 3100. According to an example, the flow passage 3130 may be formed below the driving space 3110. The driving space 3110 is a space driven by the plunger 3500, and the flow passage 3130 is a passage through which the first liquid flows. The driving space 3110 and the flow passage 3130 may be partitioned by the diaphragm 3300 to be described later.

An inlet port 3151 is formed on one side surface of the body 3100. The first liquid supply pipe 2173 of the first liquid supply source 2171 is connected to the inlet port 3151. An outlet port 3153 is formed on the other side surface of the body 3100. The first liquid supply pipe 2173 of the first liquid supply nozzle 2175 is connected to the outlet port 3153. The flow passage 3130 connects the inlet port 3151 and the outlet port 3153. Accordingly, the first liquid flowing into the body 3100 through the inlet port 3151 may flow through the flow passage 3130, and then may be discharged through the outlet port 3153.

The flow passage 3130 includes an inlet path 3131 connected to the inlet port 3151, an outlet path 3133 connected to the outlet port 3153, and a buffer space 3135 provided between the inlet path 3131 and the outlet path 3133.

The diaphragm 3300 opens and closes the flow passage 3130, and partitions the driving space 3110 from the flow passage 3130. Accordingly, it is possible to prevent the first liquid passing through the flow passage 3130 from being introduced into the driving space 3110. The diaphragm 3300 may be moved between a closed position for closing the flow passage 3130 and an open position for opening the flow passage 3130.

The diaphragm 3300 may include a coupling part 3310 and an opening/closing part 3330. The coupling part 3310 is fixedly coupled to the body 3100. The coupling part 3310 may be provided in the form of a thin film. The coupling part 3310 may be formed of an elastic material. According to an example, the coupling part 3310 may be formed of rubber, plastic, metal, or a composite material thereof.

The opening/closing part 3330 may extend from the coupling part 3310 and may open or close the flow passage 3130. According to an example, the opening/closing part 3330 may open or close an outlet of the inlet passage 31131. The opening/closing part 3330 may be formed of a material having high rigidity in which deformation is not generated during an opening/closing process. According to an example, the opening/closing part 3330 may be formed of rubber, metal, plastic, or a composite material thereof.

The plunger 3500 is disposed in the driving space 3110 to move the diaphragm 3300 between the closed position and the open position. According to an example, the plunger 3500 may be driven vertically in the driving space 3110. The plunger 3500 may include a plate 3510 and a shaft 3530.

The plate 3510 may be provided in a substantially circular plate shape. When viewed from the top, the plate 3510 may have a size corresponding to the driving space 3110. In this case, the corresponding size includes not only the case where the plate 3510 has the same size as the driving space 3110 when viewed from the top, but also a case where the plate 3510 is finely spaced apart from the driving space 3110.

The plate 3510 may be hermetically sealed to an inner wall of the body 3100. According to an example, an O-ring 3511 may be provided on the outer surface of the plate 3510 to be hermetically sealed to the inner wall of the body 3100. Accordingly, the driving space 3110 may be divided into a first driving space 3111 in which the shaft 3530 to be described later is located and a second driving space 3111 in which the elastic body 3700 to be described later is located, and the first driving space 3111 may be sealed by the plate 3510 and the diaphragm 3300. Volumes of the first driving space 3111 and the second driving space 3113 may be changed by driving the plate 3510.

The shaft 3530 may extend from the plate 3510 in the first driving space 3111 and may be coupled to the diaphragm 3300. According to an example, the shaft 3530 may be fixedly coupled to the opening/closing part 3330 of the diaphragm 3300. The shaft 3530 may be provided in a generally cylindrical shape.

The elastic body 3700 is fixedly coupled to the plate 3510 and the body 3100 in the second driving space 3113 to provide elastic force to the plate 3510. According to an example, the elastic body 3700 may be a spring. For example, the elastic body 3700 may be a compression spring. Accordingly, the valve assembly 3000 may be a Normal Closed (NC) valve which basically maintains the closed state in which the diaphragm 3300 is at the closed position, and in which when gas is supplied from the gas unit 3900 to be described later to the first driving space 3111, the elastic body 3700 is compressed by the gas pressure so that the diaphragm 3300 moves to the open position.

A first hole 3171, a second hole 3173, and a third hole 3190 are formed in the body 3100. The first hole 3171 and the second hole 3173 are formed to communicate with the first driving space 3111, and the third hole 3190 is formed to communicate with the second driving space 3113. The first hole 3171 and the second hole 3173 may exhaust the atmosphere in the first driving space 3111 or supply gas from the gas unit 3900 to the first driving space 3111 which will be described later. According to an example, the first hole 31710 and the second hole 3173 may be disposed in the moving direction of the plunger 3500.

The first hole 3171 and the second hole 3173 are disposed to be spaced apart from each other in the moving direction of the plunger 3500. The second hole 3173 is located farther from the diaphragm 3300 than the first hole 3171. According to an example, the second hole 3173 may be disposed to be spaced apart from the first hole 3171 in the upward direction.

When the diaphragm 3300 is in the open position, the first hole 3171 and the second hole 3173 are located between the plate 3510 and the diaphragm 3300. Furthermore, the second hole 3173 may be located on a path through which the plate 3510 is moved in order to switch the diaphragm 3300 from the open position to the closed position. Accordingly, when the diaphragm 3300 is moved from the closed position to the open position or from the open position to the closed position, the plate 3510 may block the second hole 3173 so that the flow of gas through the second hole 3173 may be stopped.

The third hole 3190 provides a space in which air flowing from the outside to the second driving space 3113 or air flowing from the second driving space 3113 to the outside may flow when the plate 3510 is moved. According to an example, when gas is supplied to the first hole 3171 or the second hole 3173 and the plate 3510 rises, the volume of the second driving space 3113 is reduced, and air in the second driving space 3113 may flow to the outside through the third hole 3190. In addition, when the gas is exhausted to the first hole 3171 or the second hole 3173 and the plate 3510 descends by the elastic force of the elastic body 3700, the volume of the second driving space 3113 increases, and outside air may flow into the second driving space 3113 through the third hole 3190.

The gas unit 3900 supplies gas to the first driving space 3111 or exhausts the atmosphere in the first driving space 3111. The gas unit 3900 includes a gas supply source 3910, a first main pipe 3930, a flow rate adjusting unit 3950, a second main pipe 3970, and an exhaust pipe 3990.

The gas supply source 3910 supplies gas to the first driving space 3111 through the first main pipe 3930 and the second main pipe 3970. According to an example, the gas supply source 3910 may be connected to the first main pipe 3930. According to an example, the gas may be air.

The first main pipe 3930 flows the gas supplied from the gas supply source 3910 into the first driving space 3111 through the first hole 3171 or flows the gas exhausted from the first driving space 3111 into the exhaust pipe 3990. A supply valve 3931 opening and closing the internal flow path thereof is installed in the first main pipe 3930. The supply valve 3931 is installed on the side of the gas supply source 3910 in the first main pipe 3930 and adjusts the supply of gas to the first driving space 3111. According to an example, the supply valve 3931 may be provided between the gas supply source 3910 and a point at which the second main pipe 3970 to be described later is connected to the first main pipe 3930.

In the first main pipe 3930, the flow rate adjusting unit 3950 that controls the flow rate of the fluid flowing in the first main pipe 3930 is installed. According to an example, the flow rate adjusting unit 3950 may control the flow rate of the gas exhausted from the first driving space 3111.

The flow rate adjusting unit 3950 includes a first parallel pipe 3955, a needle valve 3951, and a check valve 3953. Each of both ends of the first parallel pipe 3955 may be connected to the first main pipe 3930 at the side of the first hole 3171, so that the first parallel pipe 3955 may be disposed in parallel with the first main pipe 3930.

The needle valve 3951 is installed in the first main pipe 3930 between points at which both ends of the first parallel pipe 3955 are connected to the first main pipe 3930. The needle valve 3951 may adjust the flow rate of the gas passing through the first main pipe 3930.

The check valve 3953 is installed in the first parallel pipe 3955. The check valve 3953 only allows the flow of gas passing through the first parallel pipe 3955 in a single direction and blocks the flow of gas in the reverse direction. According to an example, the check valve 3953 may be configured in a meter-out method that blocks the flow of gas exhausted from the first driving space 3111 in the first parallel pipe 3955.

The second main pipe 3970 flows the gas supplied from the gas supply source 3910 to the first driving space 3111 through the second hole 3173 or flows the gas exhausted from the first driving space 3111 to the exhaust pipe 3990.

According to an example, the second main pipe 3970 may be connected to the first main pipe 3930. The second main pipe 3670 may be connected to the first main pipe 3930 on a side opposite to the first hole 3171 with respect to the flow rate adjusting unit 3950. Accordingly, the gas supplied from the gas supply source 3910 sequentially passes through the first main pipe 3930 and the second main pipe 3970 and flows to the first driving space 3111 through the second hole 3173, and the gas in the first driving space 3111 sequentially passes through the second main pipe 3970, the first main pipe 3930, and the exhaust pipe 390 through the second hole 3173 and is exhausted to the outside.

The flow rate adjusting unit 3950 may be installed only in the first main pipe 3930 among the first main pipe 3930 and the second main pipe 3970, and the flow rate adjusting unit 3950 may be installed in the first main pipe 3930 at a position on the side of the first hole 3171 relative to a point where the second main pipe 3970 is connected to the first main pipe 3930. Accordingly, the gas flowing in the internal flow path of the second main pipe 3970 may flow without any separate resistance, and the flow rate of the gas flowing in the internal flow path of the first main pipe 3930 may be controlled by the flow rate adjusting unit 3950.

The exhaust pipe 3990 exhausts the atmosphere in the first driving space 3111. According to an example, the exhaust pipe 3990 may be connected to the first main pipe 3930. For example, the exhaust pipe 3990 may be connected to the first main pipe 3930 between points where the supply valve 3931 and the second main pipe 3970 are connected to the first main pipe 3930. An exhaust valve 3991, which opens and closes the internal flow path thereof, may be installed in the exhaust pipe 3990.

The controller 30 may control the valve assembly 3000 and the substrate processing apparatus 1 including the same so as to perform a substrate processing method described below. For example, the controller 30 may open and close the flow passage 3130 by controlling opening and closing of the supply valve 3931 and the exhaust valve 3991 of the gas unit 3900.

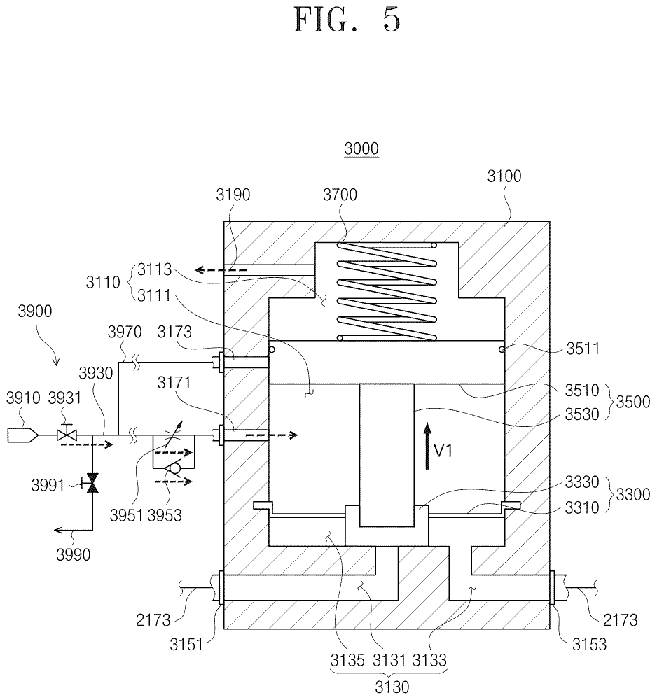

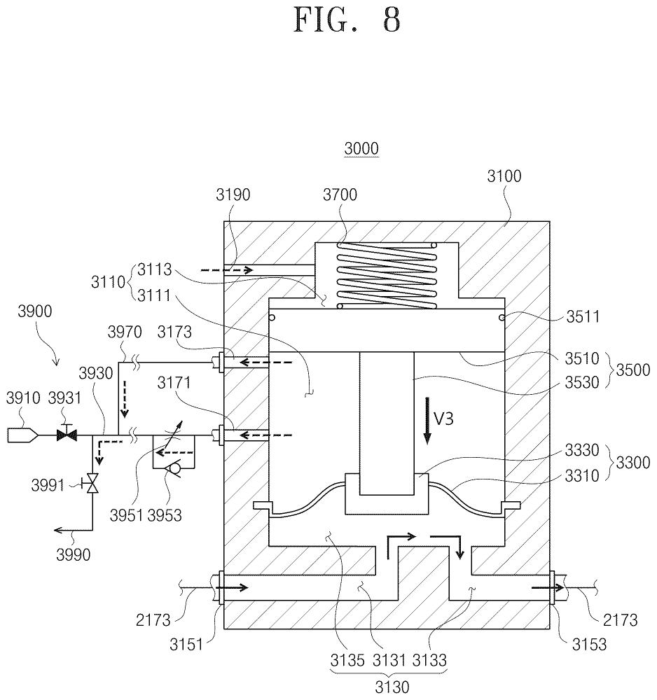

FIG. 5 to FIG. 7 are diagrams schematically illustrating a series of processes of moving the diaphragm in the valve assembly from the closed position to the open position and FIG. 8 to FIG. 10 are diagrams schematically illustrating a series of processes of moving the diaphragm from the open position to the closed position. In FIGS. 5 to 10, a dotted arrow indicates the flow of gas, and a solid arrow indicates the flow of the first liquid. In addition, the valve with an empty inside represents the open state, and the valve with a filled inside represents the closed state.

When the first liquid supply member 2100 is moved to the process position, as illustrated in FIG. 5, the controller 30 opens the supply valve 3931 and closes the exhaust valve 3991 to move up the diaphragm 3300 in the closed position to the open position.

The gas supplied from the gas supply source 3910 passes through the needle valve 3951 and the check valve 3953, and flows into the first driving space 3111 through the first hole 3171. The flow rate of the gas passing through the needle valve 3951 may be less than the flow rate of the gas passing through the check valve 3953. The second hole 3173 is blocked by the plate 3510, and thus the gas cannot flow. The pressure in the first driving space 3111 increases due to the supply of the gas, and the plunger 3500 and the diaphragm 3300 moves up by the gas pressure. In this case, the plunger 3500 may moves up at the speed of V1.

Due to the ascending of the plate 3510, the elastic body 3700 is compressed, and the volume of the second driving space 3113 is reduced. As the volume of the second driving space 3113 decreases, the air in the second driving space 3113 flows to the outside through the third hole 3190.

The plunger 3500 moves at the speed of V1 until the plate 3510 ascends and does not block the second hole 3173. When the diaphragm 3300 ascends, the flow passage 3130 is opened, and thus the first liquid introduced from the first liquid supply pipe 2173 connected to the inlet port 3151 sequentially passes through the inlet path 3131, the buffer space 3135, and the outlet path 3133 and flows to the first liquid supply pipe 2173 connected to the outlet port 3153.

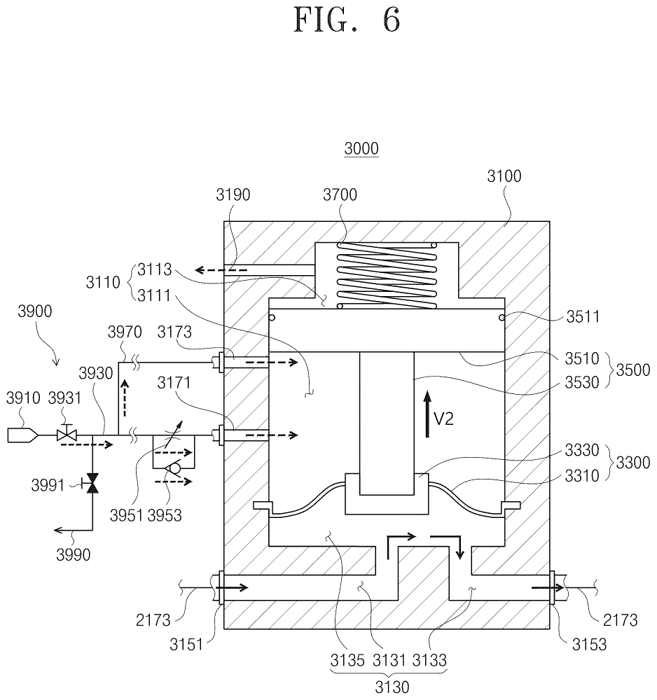

Thereafter, as illustrated in FIG. 6, the gas supplied through the gas supply source 3910 flows through the first main pipe 3930 and the second main pipe 3970, and is supplied to the first driving space 3111 through the first hole 3171 and the second hole 3173. The supply amount of the gas in the first driving space 3111 increases, so that the pressure increase width in the first driving space 3111 increases, and the plunger 3500 moves up at the speed of V2 faster than V1.

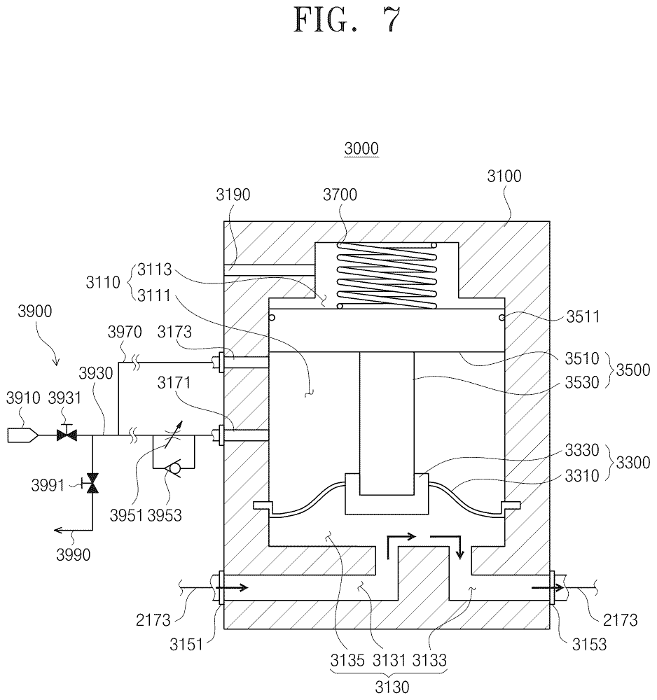

Thereafter, when the diaphragm 3300 is positioned at the open position, the supply valve 3931 is closed to stop the gas supply, as illustrated in FIG. 7. A position of the plunger 3500 is fixed by the internal pressure of the first driving space 31111. The first liquid passes through the flow passage 3130 and flows to the first liquid supply pipe 2173, and is supplied to the substrate W through the first liquid supply nozzle 2175.

After a first liquid discharge time preset in the controller 30 is elapsed, the controller 30 closes the supply valve 3931 and opens the exhaust valve 3991 to move down the diaphragm 3300 in the open position to the closed position as illustrated in FIG. 8.

The gas in the first driving space 3111 may sequentially flow through the second main pipe 3970, the first main pipe 3930, and the exhaust pipe 3990 through the second hole 3173 and be exhausted to the outside, or may sequentially flow the first main pipe 3930 and the exhaust pipe 3990 through the first hole 3171 and be exhausted to the outside. In this case, the gas passes through the needle valve 3951 of the flow rate adjusting unit 3950, but the check valve 3953 is configured in a meter-out method, so that the gas may not pass through the needle valve 3951. Accordingly, the flow rate of the gas flowing through the second main pipe 3970 may be greater than the flow rate of the gas flowing through the first main pipe 3930 between a point where the second main pipe 3970 is connected to the first main pipe 3930 and the first hole 3171.

As the gas in the first driving space 3111 is exhausted, the pressure in the first driving space 3111 is lowered, and the plunger 3500 and the diaphragm 3300 moves down by the elastic force of the elastic body 3700. In this case, the plunger 3500 may move down at the speed of V3.

As the plate 3510 moves down, the volume of the second driving space 3113 increases, and thus air flows from the outside to the second driving space 3113 through the third hole 3190.

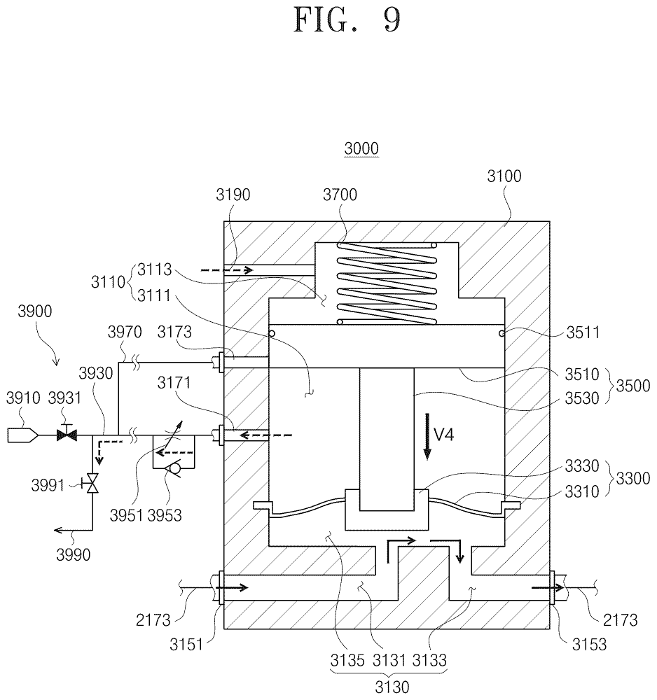

The plunger 3500 moves down at the speed of V3 to a preset position where the plate 3510 blocks the second hole 3173. When the plunger 3500 moves down to the preset position, the gas in the first driving space 3111 is exhausted to the outside through the first hole 3171 as illustrated in FIG. 9, and the second hole 3173 is blocked by the plate 3510 so that no gas flows. The flow rate of the gas exhausted from the first driving space 3111 decreases, so that the pressure reduction width in the first driving space 3111 decreases, and the plunger 3500 moves down at the speed of V4 which is slower than that of the V3.

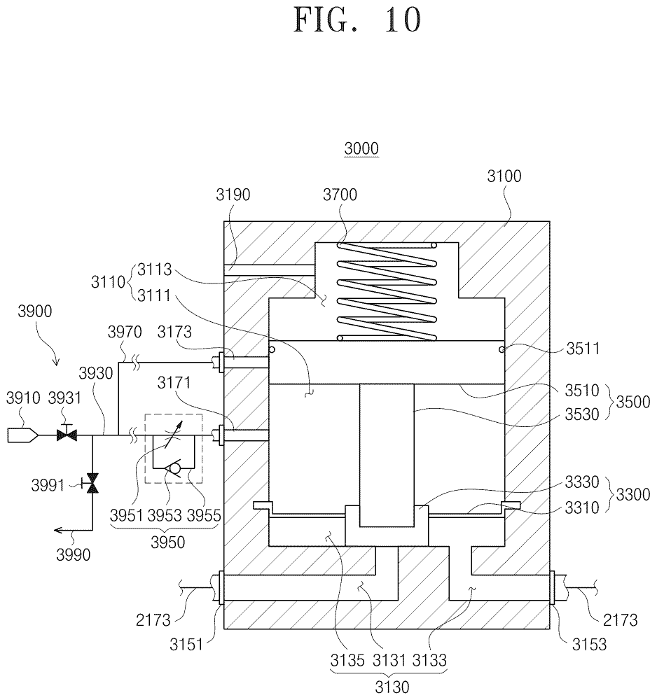

Thereafter, when the diaphragm 3300 is positioned at the closed position, the exhaust valve 3991 is closed as illustrated in FIG. 10. The opening/closing part 3330 closes the outlet of the inflow path 3131 so that the first liquid cannot flow to the first liquid supply pipe 2173 connected to the outlet port 3153 and the supply of the first liquid to the substrate W is stopped.

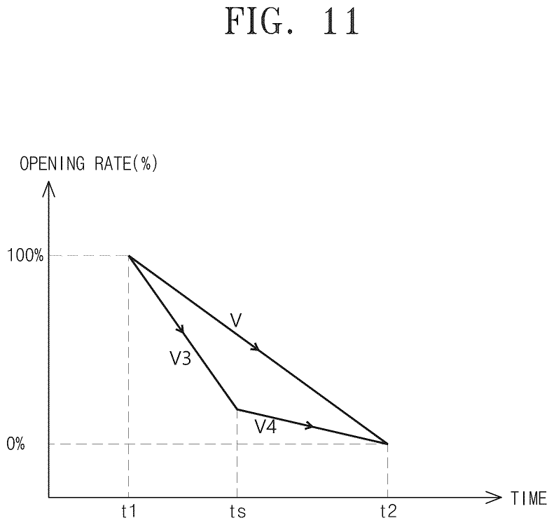

FIG. 11 is a graph schematically illustrating the closing speeds when the flow passages of the valve assembly according to the exemplary embodiment of the present invention and a flow passage of the valve assembly in the related art are closed. In the valve assembly 5000 in the related art, as illustrated in FIG. 1, since gas in the driving space is exhausted only through one hole 5151 when the plunger 5300 moves down, the speed at which the flow passage 5130 is closed may be set only at a single speed. The valve assembly 5000 in the related art closes the flow passage at a high speed V to prevent droplet collision with other treatment liquids despite the occurrence of multiple particles.

On the other hand, in the valve assembly 3000 according to the exemplary embodiment of the present invention, the first hole 3171 and the second hole 3173 are located between the plate 3510 and the diaphragm 3300 at the open position, so that the valve assembly 3000 may move down at the speed of V3 from the open position to the preset position, and may slowly move down at the speed of V4 from the preset position to the closed position. Immediately before the flow passage 3130 is closed, the operating speed V4 of the diaphragm 3300 is slowed, and thus the occurrence of particles may be minimized by reducing the amount of impact applied to the diaphragm 3300 by the treatment liquid.

In addition, since the plunger 3500 is operated at the high speed V3 from the open position to the preset position, even when the plunger 3500 operates at the slow speed V4 from the preset position to the closing position, the time (t1 to t2) required for closing may be maintained the same as the valve assembly in the related art. Accordingly, process efficiency may be improved.

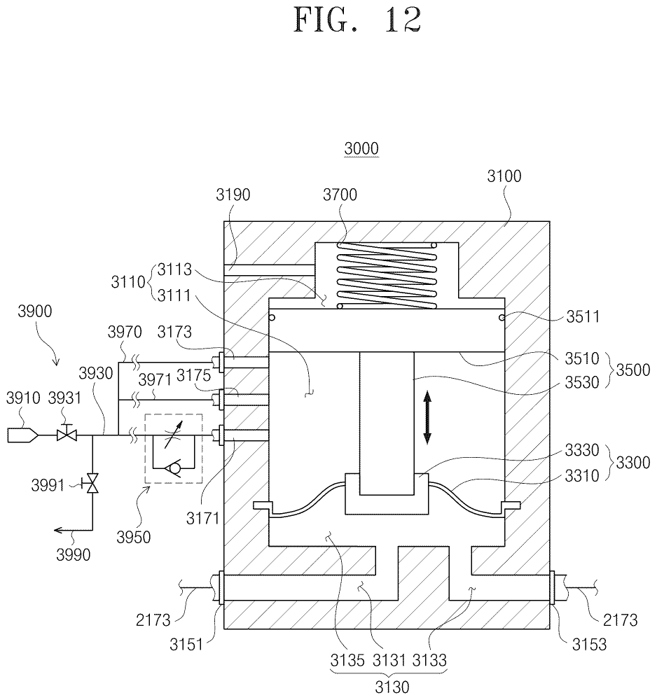

In the exemplary embodiment of FIG. 4 described above, the case where the first driving space 3111 is in contact with the first hole 3171 and the second hole 3173 has been described as an example. However, the present invention is not limited thereto, and as illustrated in FIG. 12, the first driving space 3111 may be in contact with the fourth hole 3175 as well as the first hole 3171 and the second hole 3173. The fourth hole 3175 may be in connection with the third main pipe 3971 to supply gas to the first driving space 3111 or to exhaust the gas inside the first driving space 3111 to the outside. The third main pipe 3971 may be in contact with the second main pipe 3970. However, the present invention is not limited thereto, and the third main pipe 3971 may be in contact with the first main pipe 3930.

The fourth hole 3175 may be located on a movement path of the plate 3510 when the diaphragm 3300 is moved from the open position to the closed position. Accordingly, when the plunger 3500 moves from the open position to the closed position or from the closed position to the open position, the plunger 3500 may be driven at three driving speeds depending on whether gas flows in the second hole 3173 and the fourth hole 3175. In addition, the present invention is not limited thereto, and four or more holes connected to the first driving space 3111 may be formed in the body 3100.

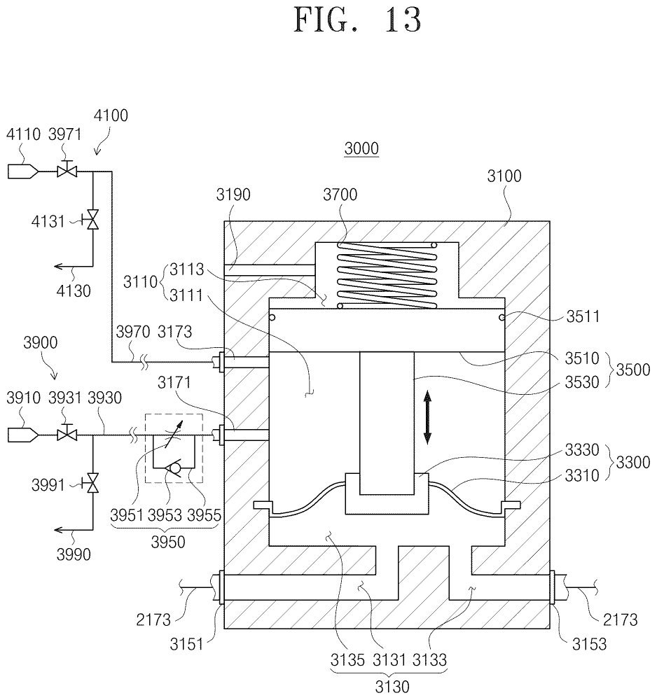

In the exemplary embodiment of FIG. 4, the case where the second main pipe 3970 is connected to the first main pipe 3930 has been described as an example. However, the present invention is not limited thereto, and as illustrated in FIG. 13, a second gas unit 4100 may be provided to supply gas to the first driving space 3111 through the second hole 3173 or to exhaust the gas in the first driving space 3111. The second gas unit 4100 may include a gas supply source 4110, a second main pipe 3970, a supply valve 3971, an exhaust pipe 4130, and an exhaust valve 4131. The controller 30 may control the supply valve 3971 and the exhaust valve 4131 of the second gas unit 4100.

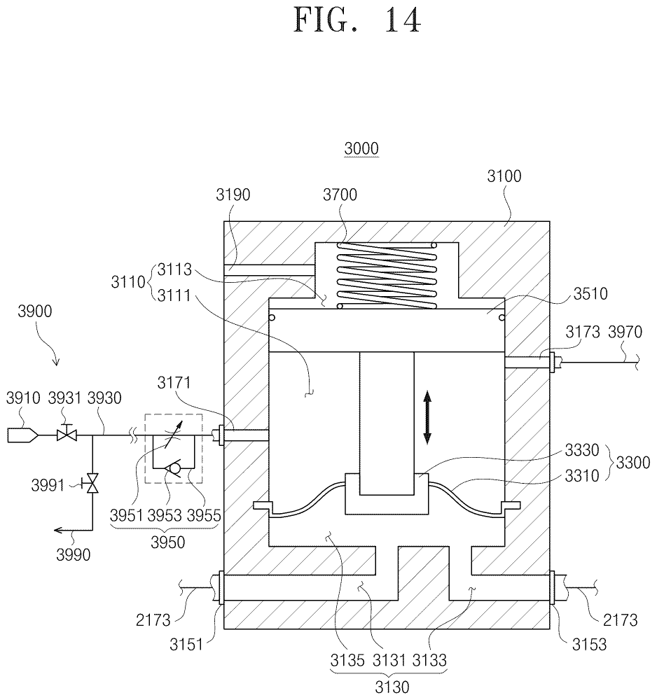

In the above-described exemplary embodiment of FIG. 4, the case where the first hole 3171 and the second hole 3173 are arranged in a direction parallel to the moving direction of the plunger 3500 has been described as an example. However, the present invention is not limited thereto, and as illustrated in FIG. 14, the first hole 3171 and the second hole 3173 may not be arranged in a direction parallel to the moving direction of the plunger 3500. In this case, the second main pipe 3970 may be connected to the first main pipe 3930, and a separate gas supply source and exhaust pipe may be provided to the second main pipe 3970.

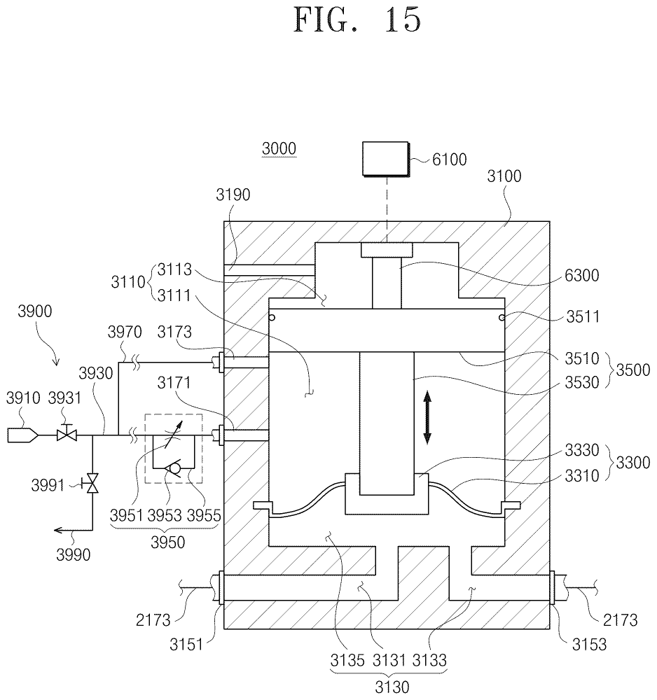

In the exemplary embodiment of FIG. 4 described above, the case where the elastic body 3700 is coupled to the plate 3510 has been described as an example. However, the present invention is not limited thereto, and as illustrated in FIG. 15, a cylinder 6300 may be coupled to the plate 3510, and the plunger 3500 may be driven by a driver 6300.

In the above-described exemplary embodiments, the case where the valve assembly 3000 is installed on the liquid supply pipe for applying a cleaning liquid on the substrate W has been described as an example. However, unlike this, the valve assembly 3000 may be installed on a liquid supply pipe supplying a photoresist, an etchant, or another kind of liquid on the substrate W. Further, the valve assembly 3000 may be installed on various known liquid supply pipes as well as a liquid supply pipe supplying a liquid on the substrate W.

In the exemplary embodiment of FIG. 4 described above, the case in which the diaphragm 3300 has the coupling part 3310 and the opening/closing part 3330 has been described as an example. However, unlike this, the diaphragm 3300 may be provided with only the coupling part 3310 that partitions the driving space 3110 from the flow passage 3130, and the coupling part 3310 may be provided to open and close the flow passage 3130.

In the above-described exemplary embodiment of FIG. 4, the case where the plunger 3500 is fixedly coupled to the diaphragm 3300 has been described as an example. However, unlike this, the plunger 3500 may not be fixedly coupled to the diaphragm 3300. When the plunger 3500 closes the flow passage 3130, the plunger 3500 may contact the diaphragm 3300 to allow the diaphragm 3300 to be positioned at the closed position, and when the diaphragm 3300 is in the open position, the plunger 3500 may not be in contact with the diaphragm 3300.

In the exemplary embodiment of FIG. 4 described above, the case where the flow rate adjusting unit 3950 includes a needle valve, a first parallel valve, and a check valve has been described as an example. However, the present invention is not limited thereto, and the flow rate adjusting unit 3950 may be an orifice installed in the first main pipe.

In the above exemplary embodiments, the case where the diaphragm 3300 opens and closes the outlet of the inflow path 3131 has been described as an example. However, unlike this, the diaphragm 3300 may be provided to open and close the inlet of the outflow path 3133.

In the above-described exemplary embodiment of FIG. 4, the case where the valve assembly 3000 is an NC type has been described as an example. However, unlike this, the valve assembly 3000 may be a Normal Open (NO) valve. In this case, the elastic body 3700 may be a tensile spring.

In the above-described exemplary embodiment of FIG. 4, the case in which the plunger 3500 of the valve assembly 3000 is driven in the vertical direction has been described as an example. However, the driving direction of the plunger 3500 is not limited to the vertical direction, and the driving space 3110 and the flow passage 3130 may be horizontally arranged, and the plunger 3500 may be driven in the horizontal direction.

The specification described above provides examples of the present disclosure. Further, the description provides exemplary embodiments of the present disclosure and the present disclosure may be used in other various combinations, changes, and environments. That is, the present disclosure may be changed or modified within the scope of the present disclosure described herein, within a range equivalent to the description, and/or within the knowledge or technology in the related art. The embodiment shows an optimum state for achieving the spirit of the present disclosure and may be changed in various ways for the detailed application fields and use of the present disclosure. Therefore, the detailed description of the present disclosure is not intended to limit the present disclosure in the embodiment. Further, the claims should be construed as including other embodiments.

What is claimed is:

1. An apparatus for processing a substrate, the apparatus comprising:
a housing having a treatment space;
a support unit for supporting and rotating a substrate in the treatment space;
a nozzle for supplying a treatment liquid to an upper surface of the substrate; and
a treatment liquid supply pipe for flowing the treatment liquid to the nozzle,
wherein a valve assembly for opening and closing an internal flow path is installed in the treatment liquid supply pipe,
the valve assembly includes:
a body which has an inlet port and an outlet port, and is formed with a driving space and a flow passage connecting the inlet port and the outlet port therein;
a diaphragm provided to open and close the flow passage and partition the flow passage from the driving space; and
a plunger placed in the driving space and moving the diaphragm between a closed position that closes the flow passage and an open position that opens the flow passage,
the plunger includes:
a plate having a size corresponding to the driving space when viewed from the top; and
a shaft extending from the plate,
the body is formed with a first hole and a second hole connected to the driving space to exhaust atmosphere in the driving space,
the first hole and the second hole are disposed to be spaced apart from each other in a moving direction of the plunger, and
when the diaphragm is in the open position, the first hole and the second hole are located between the plate and the diaphragm.

2. The apparatus of claim 1, wherein the second hole is positioned on a path through which the plate is moved to switch the diaphragm from the open position to the closed position.

3. The apparatus of claim 1, wherein the second hole is positioned farther from the diaphragm than the first hole, and
a first main pipe in which gas flows is connected to the first hole.

4. The apparatus of claim 3, wherein a flow rate adjusting unit for controlling a flow rate of gas passing through an inside of the first main pipe is installed in the first main pipe.

5. The apparatus of claim 4, wherein the flow rate adjusting unit includes:
a needle valve installed in the first main pipe; and
a first parallel pipe disposed in parallel with the needle valve and including a check valve installed.

6. The apparatus of claim 4, wherein the flow rate adjusting unit is an orifice.

7. The apparatus of claim 4, wherein a second main pipe through which gas flows is connected to the second hole, and
the second main pipe is connected to the first main pipe on a side opposite to the first hole with respect to the flow rate adjusting unit.

8. The apparatus of claim 7, wherein the flow rate adjusting unit is provided only in the first main pipe among the first main pipe and the second main pipe.

9. The apparatus of claim 1, wherein the first hole and the second hole are configured such that, when the diaphragm is moved from the open position to the closed position, the diaphragm moves from the open position to a preset position at a first speed and moves from the preset position to the closed position at a second speed different from the first speed.

10. The apparatus of claim 9, wherein the first speed is higher than the second speed.

11. The apparatus of claim 7, wherein the valve assembly further includes:
a gas supply source for supplying gas to the first main pipe;
an exhaust pipe connected to the first main pipe between points where the gas supply source and the second main pipe are connected to the first main pipe;
a supply valve installed in the first main pipe between points where the gas supply source and the exhaust pipe are connected to the first main pipe to open and close the first main pipe; and
an exhaust valve installed in the exhaust pipe to open and close the exhaust pipe.

12. The apparatus of claim 11, further comprising:
an elastic body combined with the other surface of the plate and the body to provide elastic force to the plate; and
a controller for controlling the supply valve and the exhaust valve,
the controller supplies gas to the driving space to move the diaphragm from the closed position to the open position by opening the supply valve and closing the exhaust valve, and moves the diaphragm from the open position to the closed position by the elastic force of the elastic body by closing the supply valve and opening the exhaust valve.

13. The apparatus of claim 1, wherein the flow passage includes:
an inlet path connected to the inlet port;
an outlet path connected to the outlet port; and
a buffer space provided between the inlet path and the outlet path, and
the diaphragm has
a coupling part fixedly coupled to the body; and
an opening/closing part extending from the coupling part and opening/closing an outlet of the inlet path or an inlet of the outlet path.

14. A valve assembly comprising:
a body which has an inlet port and an outlet port, and is formed with a driving space and a flow passage connecting the inlet port and the outlet port therein;
a diaphragm provided to open and close the flow passage and partition the flow passage from the driving space; and
a plunger placed in the driving space and moving the diaphragm between a closed position that closes the flow passage and an open position that opens the flow passage,
wherein the plunger includes:
a plate having a size corresponding to the driving space when viewed from the top; and
a shaft extending from the plate,
the body is formed with a first hole and a second hole connected to the driving space to exhaust atmosphere in the driving space or supply gas to the driving space,
the first hole and the second hole are disposed to be spaced apart from each other in a moving direction of the plunger, and
when the diaphragm is in the open position, the first hole and the second hole are located between the plate and the diaphragm.

15. The valve assembly of claim 14, wherein the second hole is positioned on a path through which the plate is moved to switch the diaphragm from the open position to the closed position.

16. The valve assembly of claim 15, wherein a first main pipe through which gas flows is connected to the first hole, and
a flow rate adjusting unit for controlling a flow rate of gas passing through an inside of the first main pipe is installed in the first main pipe.

17. The valve assembly of claim 14, wherein the first hole and the second hole are configured such that, when the diaphragm is moved from the open position to the closed position, the diaphragm moves from the open position to a preset position at a first speed and moves from the preset position to the closed position at a second speed different from the first speed.

18. The valve assembly of claim 17, wherein the first speed is higher than the second speed.

19. An apparatus for processing a substrate, the apparatus comprising:
a housing having a treatment space;
a support unit for supporting and rotating a substrate in the treatment space;
a nozzle for supplying a treatment liquid to an upper surface of the substrate; and
a treatment liquid supply pipe for flowing the treatment liquid to the nozzle,
wherein a valve assembly for opening and closing an internal flow path is installed in the treatment liquid supply pipe,
the valve assembly includes:
a body which has an inlet port and an outlet port, and is formed with a driving space and a flow passage connecting the inlet port and the outlet port therein;
a diaphragm provided to open and close the flow passage and partition the flow passage from the driving space; and
a plunger placed in the driving space and moving the diaphragm between a closed position that closes the flow passage and an open position that opens the flow passage,
the plunger includes:
a plate having a size corresponding to the driving space when viewed from the top; and
a shaft extending from the plate,
the body is formed with a first hole and a second hole connected to the driving space to exhaust atmosphere in the driving space or supply gas to the driving space,
the first hole and the second hole are disposed to be spaced apart from each other in a moving direction of the plunger, and
when the diaphragm is in the open position, the first hole and the second hole are located between the plate and the diaphragm,
the second hole is positioned on a path through which the plate is moved to switch the diaphragm from the open position to the closed position,
a first main pipe, through which gas flows and in which a flow rate adjusting unit is installed, is connected to the first hole,
a second main pipe through which gas flows is connected to the second hole, and
the second main pipe is connected to the first main pipe on a side opposite to the first hole with respect to the flow rate adjusting unit.

20. The apparatus of claim 19, wherein the valve assembly further includes:
a gas supply source for supplying gas to the first main pipe;
an exhaust pipe connected to the first main pipe between points where the gas supply source and the second main pipe are connected to the first main pipe;
a supply valve installed in the first main pipe between points where the gas supply source and the exhaust pipe are connected to the first main pipe to open and close the first main pipe; and
an exhaust valve installed in the exhaust pipe to open/close the exhaust pipe,
the apparatus further comprises:
an elastic body combined with the plate and the body to provide elastic force to the plate; and
a controller for controlling the supply valve and the exhaust valve, and
the controller supplies gas to the driving space to move the diaphragm from the closed position to the open position by opening the supply valve and closing the exhaust valve, and moves the diaphragm from the open position to the closed position by the elastic force of the elastic body by closing the supply valve and opening the exhaust valve.
